(19) United States
(12) Patent Application Publication
(10) Pub. No.: US 2010/0238310 A1
(43) Pub. Date: Sep. 23, 2010

(54) IMAGING APPARATUS AND DRIVE METHOD OF SOLID-STATE IMAGING DEVICE

(75) Inventor: Makoto SHIZUKUISHI, Kanagawa (JP)

Correspondence Address: Studebaker & Brackett PC, One Fountain Square, 11911 Freedom Drive, Suite 750, Reston, VA, 20190, US

(73) Assignee: FUJIFILM CORPORATION, Tokyo (JP)

(21) Appl. No.: 12/722,266

(22) Filed: Mar. 11, 2010

(30) Foreign Application Priority Data
Mar. 23, 2009 (JP) 2009-070776

(51) Int. Cl. H04N 5/225; H04N 5/335

(52) U.S. Cl. 348/220.1; 348/308; 348/306; 348/E05.031; 348/E05.024

(57) ABSTRACT

An imaging apparatus has a plurality of pixel sections. Each of the pixel sections contains a photoelectric conversion section, a floating diffusion layer FD for storing a charge and a transistor MT containing a gate electrode CG and a floating gate FG. The imaging apparatus includes a transistor LT being on-off controlled as a load transistor of the transistor MT and a control section for switching according to an image capturing mode, drive for injecting a charge responsive to a voltage supplied to the CG into the FG with the transistor LT turned off and reading a change in a threshold voltage of the transistor MT caused by the injected charge as an image capturing signal and drive for reading the voltage output from the transistor MT as an image capturing signal in response to the voltage supplied to the CG with the transistor LT turned on.

### CROSS-REFERENCE TO RELATED APPLICATIONS

This application claims the benefit of Japanese Patent Application No. 2009-070776, filed on Mar. 23, 2009, the entire contents of which are hereby incorporated by reference, the same as if set forth at length; the entire of which are incorporated herein by reference.

### BACKGROUND OF THE INVENTION

1. Technical Field

This invention relates to an imaging apparatus and a drive method of a solid-state imaging device.

2. Description of Related Art

Since lower power consumption and miniaturization are possible, a solid-state imaging device of CMOS type becomes widespread with installing the device in a mobile telephone as a start. However, an imaging apparatus of a digital camera, etc., installing a general CMOS solid-state imaging device adopts a system (rolling shutter system) wherein the exposure time period of the solid-state imaging device varies from one line to another. Thus, to capture an image of a subject changing at high speed as a still image, distortion of a capturing image, so-called image flow, is caused to occur by the difference in the start timing of the exposure time period for each line. (U.S. Pat. No. 5,471,515)

To prevent the image flow, it is effective to use together a mechanical shutter of means for mechanically shading the solid-state imaging device. However, if the mechanical shutter is used, the shutter speed can not be so increased and it becomes difficult to miniaturize and reduce the cost of the imaging apparatus.

As a method of preventing image flow without using the mechanical shutter, a method of storing a charge of one frame occurring in a photoelectric conversion section during the exposure time period in a storage section provided in each pixel section at the same time, converting the charge in the storage section into a voltage signal, and reading the voltage signal to the outside in sequence is proposed. (Junichi Nakamura, Image Sensors and Signal Processing for Digital Still camera, Taylor & Francis, Sep. 30, 2005, P171-172)

In the configuration as shown in this reference, there are problems in that five or more transistors in the pixel become necessary and the configuration is not fitted for microminiaturization of the pixel, and the image quality is impaired because of inflow of a signal charge from an adjacent pixel, a dark current, etc., since it is necessary to hold a signal charge in a floating diffusion layer (FD) in the time period until read of an image capturing signal.

Then, the inventor discloses a method of storing a charge of one frame occurring in a photoelectric conversion section during the exposure time period in a floating gate provided in each pixel section at the same time and reading a signal responsive to the stored charge to the outside in sequence. (JP 2002-280537-A)

According to the configuration in JP 2002-280537-A, a global shutter can be realized without complicating the structure of a pixel and it is not necessary to hold a signal charge in a floating diffusion layer and thus the effect of inflow signal charge from an adjacent pixel and a dark current is hard to receive. However, the needs for the global shutter are main in the case of high-definition still image photographing; for example, when the angle of view is set on a liquid crystal monitor, etc., photographing with low resolution and in a moving image mode (photographing with a rolling shutter) is often sufficient. In such a case, simultaneity of image record is not required in an image sensor having the floating gate structure in JP 2002-280537-A and there is a demand for a method capable of easily switching a moving image mode and a still image mode from the viewpoint of rewrite durability of the floating gate at the long-time use time.

### SUMMARY

In view of the circumstances described above, it is an object of the invention to provide an imaging apparatus and a drive method of a solid-state imaging device being capable of easily switching smooth moving image capturing and high-quality still image capturing without using a mechanical shutter.

An imaging apparatus includes a plurality of pixel sections, a second transistor, a first signal read unit and a second signal read unit. The plurality of pixel sections is arranged in a row direction and a column direction orthogonal to the row direction. Each of the pixel sections includes a photoelectric conversion section, a first charge storage section and a first transistor. The first charge storage section stores a charge occurring in the photoelectric conversion section. The first transistor has a gate electrode connected to the first charge storage section and a second charge storage section provided between the gate electrode and a semiconductor substrate. The second transistor is on-off controlled as a load transistor of the first transistor. The first signal read unit injects a charge responsive to a voltage supplied to the gate electrode into the second charge storage section with the second transistor turned off. The first signal read unit reads a change in a threshold voltage of the first transistor caused by the injected charge as an image capturing signal. The second signal read unit reads a voltage output from the first transistor as an image capturing signal in response to a voltage supplied to the gate electrode with the second transistor turned on.

A drive method of a solid-state imaging device, the solid-state imaging device includes a plurality of pixel sections. The plurality of pixel sections is arranged in a row direction and a column direction orthogonal to the row direction. Each of the pixel sections includes a photoelectric conversion section, a first charge storage section and a first transistor. The first charge storage section stores a charge occurring in the photoelectric conversion section. The first transistor has a gate electrode connected to the first charge storage section and a second charge storage section provided between the gate electrode and a semiconductor substrate. The drive method of the solid-state imaging device includes: on-off controlling a second transistor as a load transistor of the first transistor; injecting by a first signal read unit, a charge responsive to a voltage supplied to the gate electrode into the second charge storage section with the second transistor turned off; reading by the first signal read unit, a change in a threshold voltage of the first transistor caused by the injected charge as an image capturing signal with the second transistor turned off; and reading by a second signal read unit, a voltage output from the first transistor as an image capturing signal in response to a voltage supplied to the gate electrode with the second transistor turned on.

According to the invention, there can be provided an imaging apparatus and a drive method of a solid-state imaging device, which are capable of easily switching smooth moving image capturing and high-quality still image capturing without using a mechanical shutter.

### BRIEF DESCRIPTION OF THE DRAWINGS

In the accompanying drawings:

FIG. 1A and FIG. 1B are plan schematics drawing to show the schematic configurations of a solid-state imaging device installed in an imaging apparatus to describe the embodiment of the invention;

FIG. 2 is an equivalent circuit diagram of a pixel section of the solid-state imaging device shown in FIG. 1A;

FIG. 3A and FIG. 3B are fragmentary sectional schematics drawing of the pixel section shown in FIG. 2;

FIG. 4 is a drawing to show the circuit configuration of the pixel section when a transistor MT in FIG. 2 is caused to function as a nonvolatile memory transistor;

FIG. 5 is a drawing to show the circuit configuration of the pixel section when the transistor MT in FIG. 2 is caused to function as a drive transistor;

FIG. 6 is a drawing to show an outline of the operation at the still image capturing mode time of the imaging apparatus installing the solid-state imaging device shown in FIG. 1A and FIG. 1B;

FIG. 7 is a timing chart to show the operation at the moving image capturing time of the imaging apparatus installing the solid-state imaging device shown in FIG. 1A and FIG. 1B; and

FIG. 8 is a timing chart to show the operation at the still image capturing time of the imaging apparatus installing the solid-state imaging device shown in FIG. 1A and FIG. 1B.

### DETAILED DESCRIPTION OF EMBODIMENTS OF THE INVENTION

An imaging apparatus (an image capturing unit, etc., installed in a digital camera, a video camera, an endoscope, or a mobile telephone with a camera) to describe one embodiment of the invention will be discussed below:

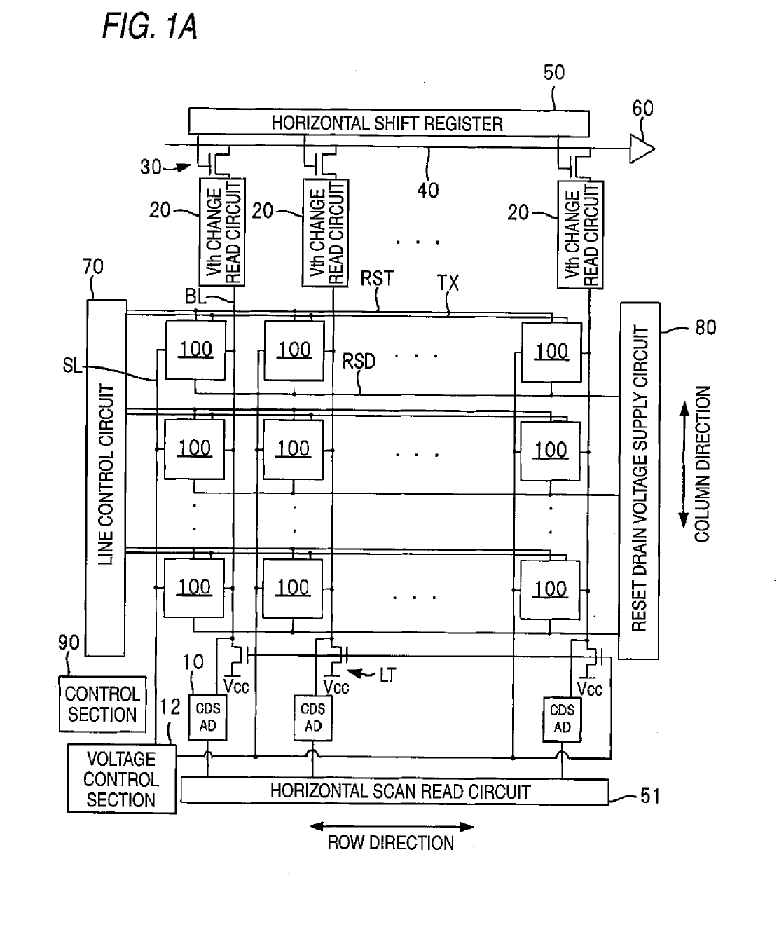

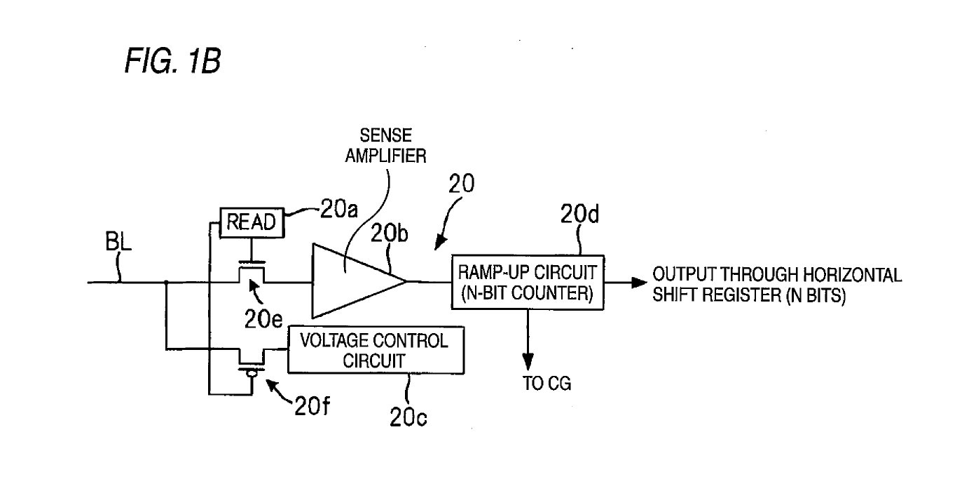

FIG. 1A and FIG. 1B are plan schematics drawing to show the schematic configurations of a solid-state imaging device installed in an imaging apparatus to describe the embodiment of the invention.

The solid-state imaging device shown in FIG. 1A includes a plurality of pixel sections 100 arranged like an array (here, like a square lattice) in a row direction and a column direction orthogonal to the row direction on the same plane. A line control circuit 70 is formed to the left of the area where the plurality of pixel sections 100 are formed, and a reset drain voltage supply circuit 80 is formed to the right of the area. Read circuits 20 and selection transistors 30 each provided for each pixel column made up of a plurality of pixel sections 100 arranged in the column direction, a horizontal shift register 50, and an output amplifier 60 are formed above the area where the plurality of pixel sections 100 are formed. Transistors LT and read circuits 10 each provided for each pixel column, a voltage control section 12, a horizontal scan read circuit 51, and a control section 90 for controlling the whole solid-state imaging device are formed below the area where the plurality of pixel sections 100 are formed. The control section 90 may be provided in the imaging apparatus in which the solid-state imaging device is installed.

From the line control circuit 70, a reset line RST and a transfer control line TX extend in the row direction above each pixel row made up of a plurality of pixel sections 100 arranged in the row direction. The reset line RST and the transfer control line TX are connected to each pixel section 100 in the pixel row corresponding thereto.

From the reset drain voltage supply circuit 80, a reset drain line RSD extends in the row direction below each pixel row. The reset drain line RSD is connected to each pixel section 100 in the pixel row corresponding thereto.

In the right side part of each pixel column, a signal output line BL extends in the column direction for each pixel column The signal output line BL is connected to each pixel section 100 of the corresponding pixel column and is also connected to the read circuit 20, the transistor LT, and the read circuit 10 provided corresponding to the pixel column.

In the left side part of each pixel column, a source line SL extends in the column direction for each pixel column The source line SL is connected to each pixel section 100 of the corresponding pixel column and is also connected to the voltage control section 12.

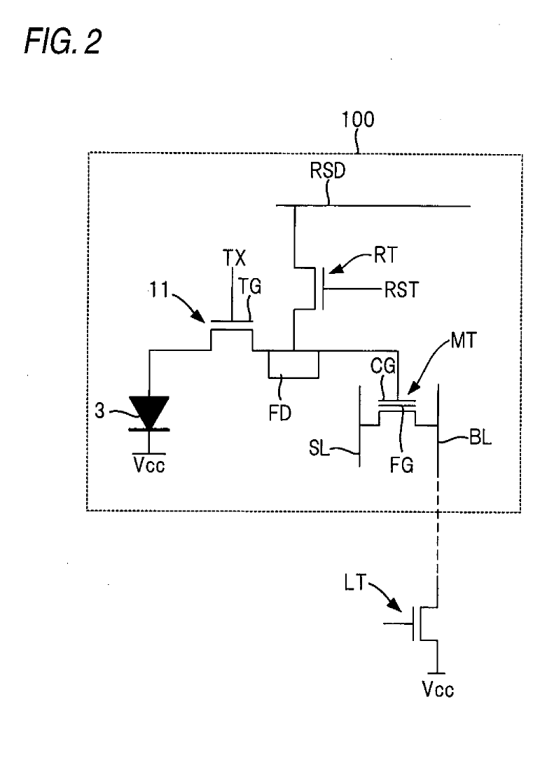

FIG. 2 is an equivalent circuit diagram of the pixel section 100 shown in FIG. 1A. As shown in FIG. 2, the pixel section 100 includes a photoelectric conversion section 3 for receiving incidence light and generating a charge responsive thereto, floating diffusion FD for storing the charge generated by the photoelectric conversion section 3, a transfer transistor 11 for transferring the charge generated by the photoelectric conversion section 3 to the floating diffusion FD, a reset transistor RT for resetting the potential of the floating diffusion FD to a predetermined potential, and a transistor MT having a floating gate FG as a charge storage part and a gate electrode CG connected to the floating diffusion FD.

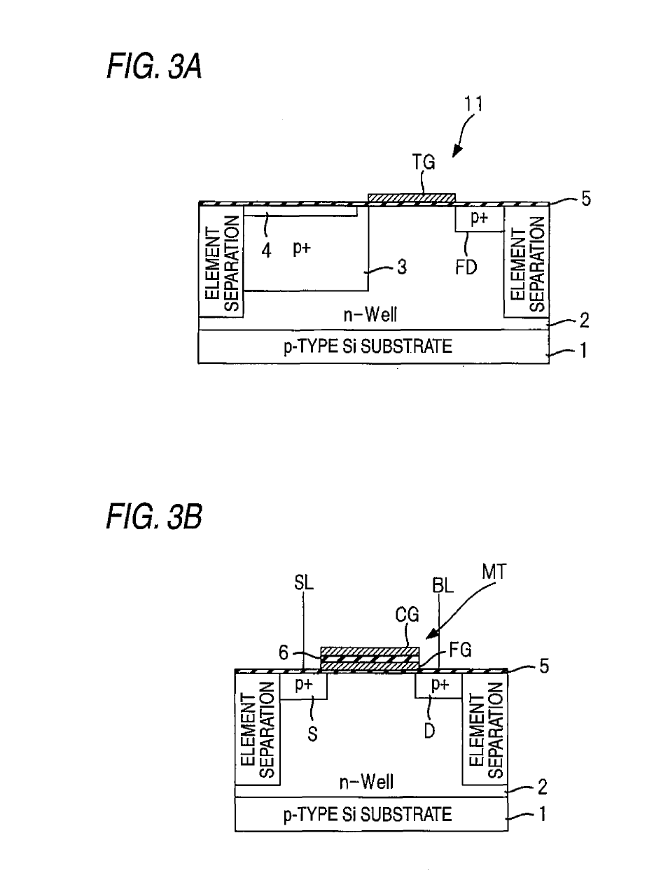

FIG. 3A and FIG. 3B are sectional schematics drawing of a part of the pixel section shown in FIG. 2. FIG. 3A is a sectional schematic drawing of the photoelectric conversion section 3, the transfer transistor 11, and the floating diffusion FD shown in FIG. 2, and FIG. 3B is a sectional schematic drawing of the transistor MT shown in FIG. 2.

As shown in FIG. 3A, an n well layer 2 is formed on a p-type silicon substrate 1, and a p-type impurity layer 3 is formed in the n well layer 2. Pn junction of the p-type impurity layer 3 and the n well layer 2 forms the photoelectric conversion section 3 (photodiode). The photodiode is an embed-type photodiode formed with an n-type impurity layer 4 for complete depletion and dark current suppression on the surface of the p-type impurity layer 3.

The floating diffusion FD made of a p-type impurity is formed at a slight distance adjacent to the p-type impurity layer 3. A transfer electrode TG is formed through an oxide film 5 on the n well layer 2 between the p-type impurity layer 3 and the floating diffusion FD. The p-type impurity layer 3, the floating diffusion FD, and the transfer electrode TG make up the transfer transistor 11.

A transfer control line TX is connected to the transfer electrode TG of the transfer transistor 11. The line control circuit 70 can control a voltage applied to the transfer control line TX separately for each pixel row and accordingly it is possible to perform on/off control of the transfer transistor 11 separately for each pixel row.

As shown in FIG. 3B, a source region S and a drain region D of the transistor MT made of a p-type impurity are formed in the n well layer 2 of the pixel section 100. The floating gate FG is formed through an oxide film 5 on the n well layer 2 between the source region S and the drain region D. An insulating film 6 is formed on the floating gate FG and a gate electrode CG is formed on the insulating film 6. The oxide film 5 below the floating gate FG has a thickness to allow a charge to be injected from the n well layer 2 (about 1 to 5 nm). The insulating film 6 has a thickness to allow insulating properties of the floating gate FG and the gate electrode CG to be held (about 2 to 10 nm).

The voltage control section 12 is connected to the source region S through the source line SL. The signal output line BL is connected to the drain region D. The drain region of the transistor LT is connected to one end of the signal output line BL, as described above. The transistor LT functions as a load transistor of the transistor MT and is a p-channel MOS transistor formed in the n well layer 2 like the transistor MT.

A power supply voltage Vcc is connected to the source area of the transistor LT and the voltage control section 12 is connected to the gate electrode. The voltage control section 12 controls the voltage applied to the gate electrode of the transistor LT, thereby performing on/off control of the transistor LT. The voltage control section 12 also has a function of controlling the voltage supplied to the source line SL.

The reset transistor RT is a p-channel MOS transistor with the p-type impurity layer 3 as a source region. The reset line RST is connected to the gate electrode of the reset transistor RT and from the line control circuit 70, the voltage applied to the reset line RST can be controlled separately for each pixel row. Accordingly, it is possible to perform on/off control of the reset transistor RT separately for each pixel row. The reset drain voltage supply circuit 80 is connected to the drain region of the reset transistor RT through the reset drain line RSD.

The reset drain voltage supply circuit 80 has a function of supplying a reset voltage for resetting the floating diffusion FD from the reset drain line RSD to the drain region of the reset transistor RT and also has a function of supplying a gate voltage to be applied to the gate electrode CG of the transistor MT. In the solid-state imaging device, the floating diffusion FD and the gate electrode CG are connected and thus the potential of the floating diffusion FD is controlled, whereby the gate voltage applied to the gate electrode CG can also be controlled. Using this, in the solid-state imaging device, the reset drain voltage supply circuit 80 applies a predetermined gate voltage to the gate electrode CG of the transistor MT through the floating diffusion FD from the drain region of the reset transistor RT.

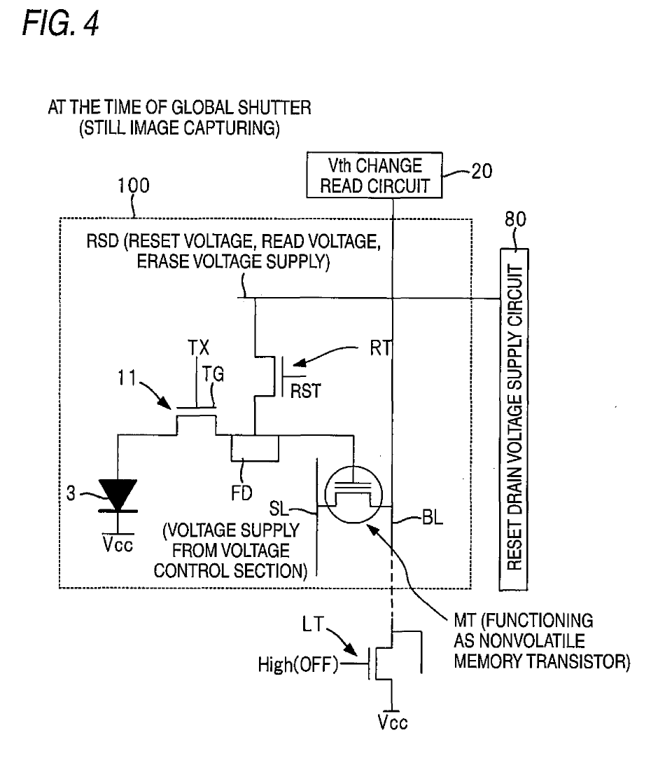

When the transistor LT is off (in a state in which a high pulse is applied from the voltage control section 12), the transistor MT functions as a nonvolatile memory transistor. FIG. 4 is a drawing to show the circuit configuration of the pixel section 100 when the transistor MT is caused to function as a nonvolatile memory transistor.

When the transistor MT functions as a nonvolatile memory transistor, if the potential of the floating diffusion FD changes in response to the charge transferred to the floating diffusion FD, the potential change is applied to the gate electrode CG of the transistor MT as a voltage and a charge is injected into the floating gate FG from the n well layer 2 by band-to-band hot electron injection (refer to JP 9-008153-A) in response to the applied voltage. That is, the charge corresponding to the charge occurring during the exposure time period in the photoelectric conversion section 3 is injected into the floating gate FG. When the charge is injected into the floating gate FG, the threshold voltage of the transistor MT changes in response to the charge amount. The read circuit 20 is a circuit for detecting the change in the threshold voltage.

The read circuit 20 is composed of a read control section 20a, a sense amplifier 20b, a voltage control circuit 20c, a ramp-up circuit 20d, and transistors 20e and 20f, as shown in FIG. 1B.

When an image capturing signal is read from the pixel section 100, the read control section 20a turns on the transistor 20f and supplies a drain voltage from the voltage control circuit 20c through the signal output line BL to the drain region D of the transistor MT of the pixel section 100 (precharge). Next, the transistor 20e is turned on and the drain region D of the transistor MT of the pixel section 100 and sense amplifier 20b are brought into conduction.

The sense amplifier 20b monitors the voltage in the drain region D of the pixel section 100 and detects a change in the voltage and notifies the ramp-up circuit 20d of the voltage change. For example, a rise in the drain voltage precharged by the voltage control circuit 20c is detected and sense amplifier output is inverted.

The ramp-up circuit 20d incorporates an N-bit counter (for example, N=8 to 12) and supplies an incremented or decremented ramp waveform voltage to the gate electrode CG of the pixel section 100 through the reset drain voltage supply circuit 80 and also outputs a count corresponding to the value of the ramp waveform voltage (combination of N 1s and 0s).

When the voltage of the gate electrode CG exceeds the threshold voltage of the transistor MT, the transistor MT conducts and at this time, the potential of the precharged signal output line BL rises. This is detected by the sense amplifier 20b and an inversion signal is output. The ramp-up circuit 20d holds (latches) the count corresponding to the value of the ramp waveform voltage at the point in time receiving the inversion signal. Accordingly, a change in the threshold voltage as a digital value (combination of 1 and 0) can be read out as an image capturing signal.

When the horizontal shift register 50 selects one horizontal selection transistor 30, the count held in the ramp-up circuit 20d connected to the horizontal selection transistor 30 is output to a signal line 40 and this is output as an image capturing signal from the output amplifier 60.

The reading method of a change in the threshold voltage of the transistor MT by the read circuit 20 is not limited to the method described above. For example, the drain current of the transistor MT when a given voltage is applied to the gate electrode and the drawing region D may be read out as an image capturing signal.

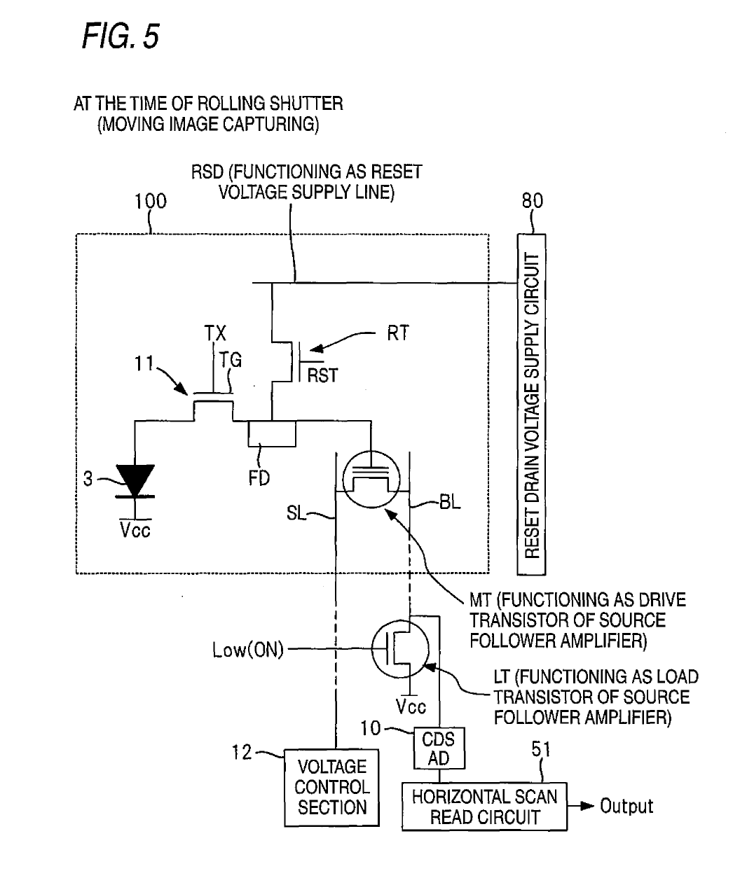

When the transistor LT is on (in a state in which a low pulse is applied from the voltage control section 12), the transistor LT and the transistor MT make up a source follower circuit. In the source follower circuit, the transistor MT functions as a drive transistor and the transistor LT functions as a load transistor of a constant current source. FIG. 5 is a drawing to show the circuit configuration of the pixel section 100 when the transistor MT is caused to function as a drive transistor of the source follower circuit.

When the transistor MT functions as a drive transistor, if the potential of the floating diffusion FD changes in response to the charge transferred to the floating diffusion FD, the potential change is applied to the gate electrode CG of the transistor MT as a voltage and the applied voltage is amplified and is input to the read circuit 10. The read circuit 10 and the horizontal scan read circuit 51 are circuits for reading an input signal from the source follower circuit to the outside as an image capturing signal. The read circuit 10 contains a CDS circuit for performing correlation double sampling processing for an output signal of the source follower circuit and an AD conversion circuit for converting an output signal of the CDS circuit into a digital signal. The horizontal scan read circuit 51 is connected to the read circuits 10. The horizontal scan read circuit 51 selects the read circuits 10 in sequence and causes the selected read circuit 10 to output an image capturing signal after subjected to the AD conversion.

Thus, the solid-state imaging device shown in FIG. 1A and FIG. 1B can read out an image capturing signal to the outside in two ways by switching on and off the transistor LT. When the transistor LT is turned off, the transistor MT can be caused to function as a nonvolatile memory transistor. The nonvolatile memory transistor can store a charge occurring in exposure in the floating gate FG, so that a global shutter with the exposure time period made the same in all pixel sections 100 can be realized. On the other hand, when the transistor LT is turned on, the source follower circuit is formed, so that a rolling shutter with the exposure time period shifted for each pixel section row can be realized as with a general CMOS image sensor. In the solid-state imaging device shown in FIG. 1A and FIG. 1B, the control section 90 drives the solid-state imaging device in the global shutter mode to realize higher image quality at the still image capturing time and drives the solid-state imaging device in the rolling shutter mode to realize a smooth moving image at the moving image capturing time. The operation at the photographing mode time in the imaging apparatus installing the solid-state imaging device will be discussed below:

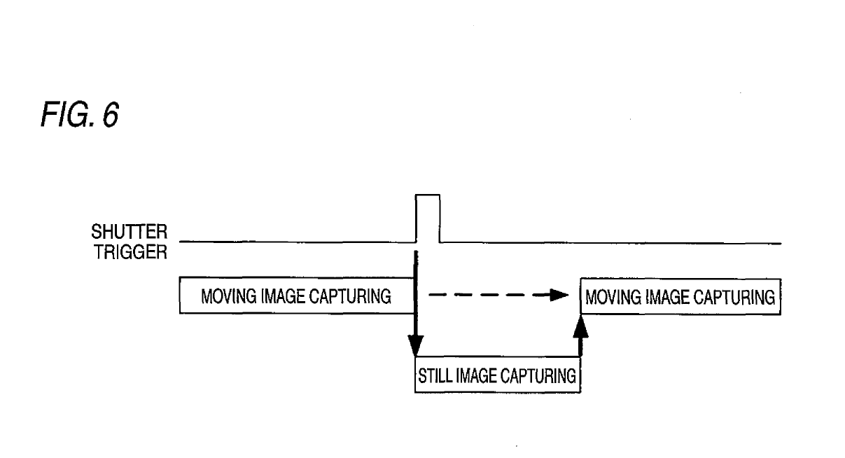

FIG. 6 is a drawing to show an outline of the operation at the still image capturing mode time of the imaging apparatus installing the solid-state imaging device shown in FIG. 1A and FIG. 1B.

As shown in FIG. 6, when the user sets the imaging apparatus to the still image capturing mode, the control section 90 first starts to capture a moving image. The image data generated in the imaging apparatus by picking up a moving image is used for monitor display and setting an image capturing condition and is not recorded on a record medium capable of external output. If the user fully presses a shutter button during moving image picking up and a shutter trigger is turned on (a command of picking up a still image is given), the control section 90 executes picking up a still image. When picking up a still image terminates and read of an image capturing signal by picking up the still image terminates, the control section 90 restarts to capture a moving image.

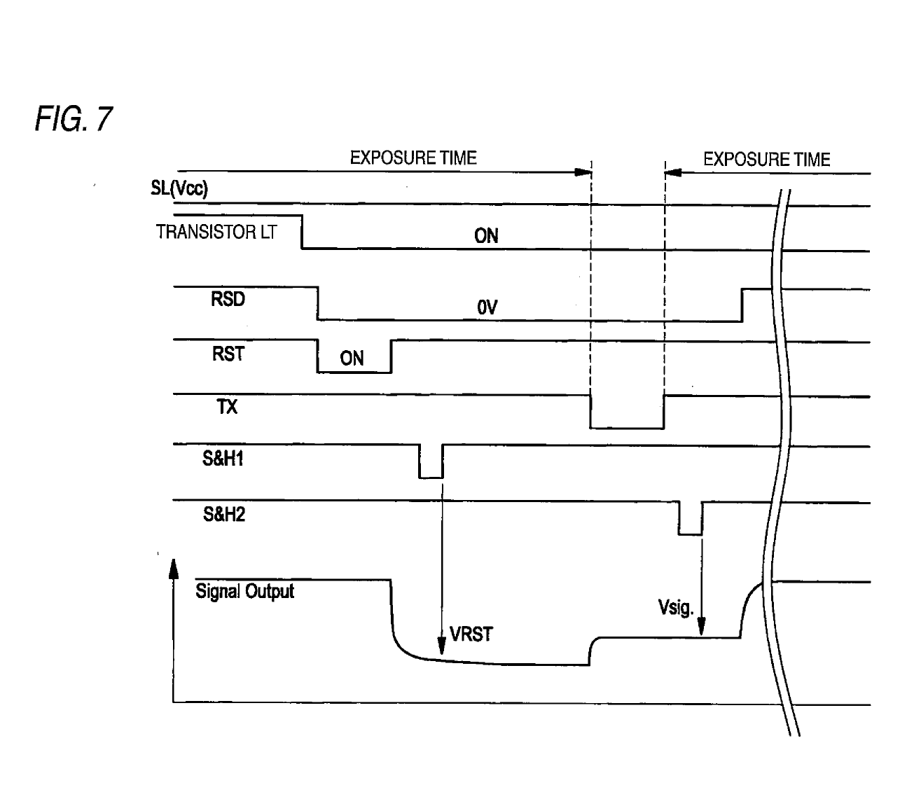

FIG. 7 is a timing chart to show the operation at the moving image capturing time of the imaging apparatus installing the solid-state imaging device shown in FIG. 1A and FIG. 1B. The following operation is executed under the control of the control section 90:

When the still image capturing mode is set and moving image capturing is started, the voltage control section 12 starts to supply power supply voltage Vcc to the source line SL and supplies a low pulse the gate electrode of the transistor LT to turn on the transistor LT. Next, before termination of exposure of the pixel sections 100 on the first row, the reset drain voltage supply circuit 80 starts to supply a predetermined reset voltage (for example, 0 V) to the reset drain line RSD connected to the pixel sections 100 on the first row. At the same time, the line control circuit 70 sets low a reset pulse to be supplied to the reset line RST connected to the pixel sections 100 on the first line only for a predetermined time period. Accordingly, before the exposure termination, the charge stored in the floating diffusion FD is discharged to the drain of the reset transistor RT and the potential of the floating diffusion FD is reset to 0 V.

When the reset pulse is restored high and the reset operation is complete, reset noise is stored in the floating diffusion FD of each of the pixel sections 100 on the first row. The reset noise is converted into a voltage signal for output by the source follower circuit made up of the transistor MT and the transistor LT, and the voltage signal is input to the read circuit 10. Signal Output in the figure indicates the image capturing signal input to the read circuit 10. After completion of the reset operation, the level of the image capturing signal falls to the level of “VRST” in response to the potential of the floating diffusion FD and becomes stable. After completion of the reset operation, when the level of the image capturing signal becomes stable, a sample hold signal (S&H1) is supplied to the read circuit 10 and the image capturing signal at the level of “VRST” is sampled and is held.

At the termination timing of the exposure time period of each of the pixel sections 100 on the first row, the line control circuit 70 sets low a transfer pulse to be supplied to the transfer control line TX connected to the pixel sections 100 on the first line and turns on the transfer transistor 11. Accordingly, the exposure time period of each of the pixel sections 100 on the first row terminates and the charge occurring in the photoelectric conversion section 3 during the exposure time period is completely transferred to the floating diffusion FD. When the line control circuit 70 restores the transfer pulse high and completes transfer of the charge, the exposure time period in the next frame is started. The level of the image capturing signal input to the read circuit 10 rises from “VRST” to the level of “Vsig” in response to the potential of the floating diffusion FD and becomes stable. When the level of the image capturing signal becomes stable, the control section 90 supplies a sample hold signal (S&H2) to the read circuit 10 and samples and holds the image capturing signal at the level of “Vsig.”

In the read circuit 10, “VRST” is subtracted from the held “Vsig,” reset noise is removed, the image capturing signal after the reset noise removal is converted into a digital signal, and the signal is output in sequence from an output buffer to a signal processing circuit at the following stage under the control of a shift register (not shown).

The control section 90 repeats the above-described sequence on and after the second row (however, the exposure start timing is shifted for each line). Thus, the operation at the moving image capturing time of the imaging apparatus is similar to the operation when a general CMOS sensor is driven in a rolling shutter system.

When a shutter trigger is turned on during moving image picking up, the control section 90 executes picking up a still image and at the termination of read of the image capturing signal by picking up a still image, the control section 90 restarts to capture a moving image.

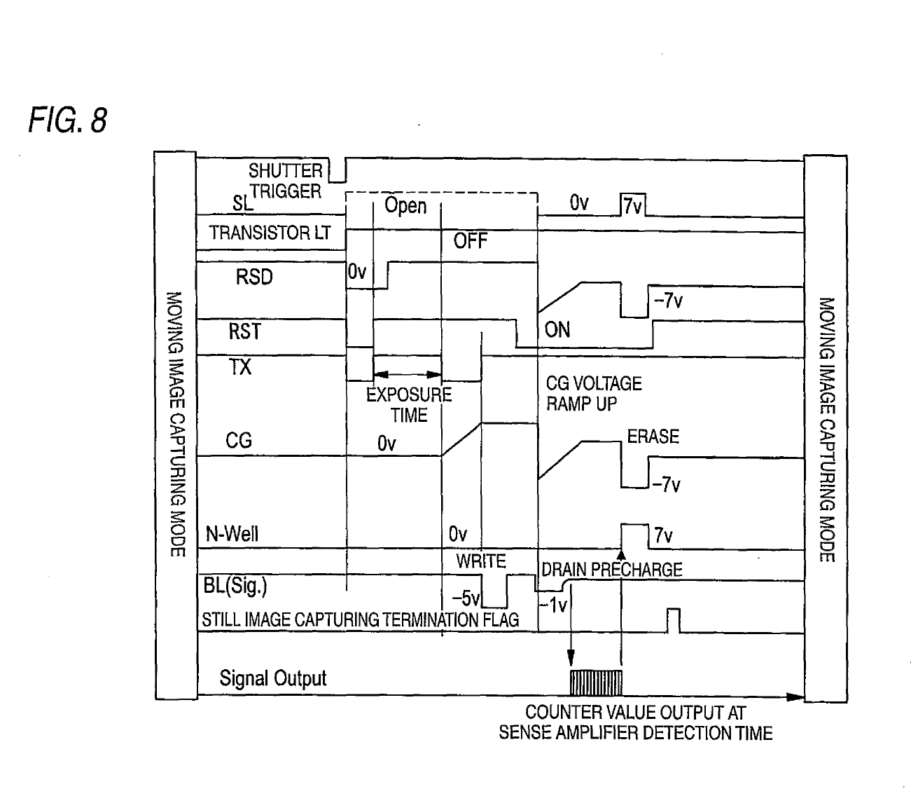

FIG. 8 is a timing chart to show the operation at the still image capturing time of the imaging apparatus installing the solid-state imaging device shown in FIG. 1A and FIG. 1B.

When the user gives a command of setting an image capturing condition to capture a still image during moving image picking up performed at the still image capturing mode time (half presses the shutter button), a system control section of the imaging apparatus performs AE and AF and sets the image capturing condition based on an image capturing signal output from the solid-state imaging device.

Next, when the shutter button is fully pressed and a shutter trigger is turned off, the control section 90 starts to capture a still image in accordance with the setup image capturing condition.

When the shutter trigger is turned off and the start timing of the exposure time period is reached, the voltage control section 12 opens the source line and sets high a pulse to be supplied to the gate electrode of the transistor LT to turn off the transistor LT. The reset drain voltage supply circuit 80 supplies a predetermined reset voltage (for example, 0 V) to all reset drain lines RSD. At the same time, the line control circuit 70 sets low a reset pulse to be supplied to all reset lines RST and a transfer pulse to be supplied to the transfer control line TX only for a predetermined time period.

Accordingly, before the exposure start, the charge stored in the photoelectric conversion sections 3 of all pixel sections 100 is transferred to the floating diffusion FD and from here is discharged to the drain of the reset transistor RT. The potential of the floating diffusion FD is reset to 0 V. When the reset pulse and the transfer pulse are restored high and the reset operation is complete, the exposure time period of every pixel section 100 is started and charge is stored in the photoelectric conversion sections 3 of all pixel sections 100.

After the termination of the exposure time period, the line control circuit 70 sets low a transfer pulse to be supplied to all transfer control lines TX to turn on the transfer transistor 11. Accordingly, the exposure time period of every pixel section 100 terminates, the charge occurring in the photoelectric conversion section 3 during the exposure time period is completely transferred to the floating diffusion FD, and the potential of the gate electrode CG rises in response to the transferred charge amount.

When the line control circuit 70 restores the transfer pulse high and completes transfer of the charge, the voltage control circuit 20c supplies a write voltage (for example, −5 V) required for injecting the charge corresponding to the charge amount transferred to the floating diffusion FD into the floating gate FG to the signal output line BL.

Accordingly, electrons responsive to the potential rise of the gate electrode CG are injected into the floating gate FG from the n well layer 2. When supply of the write voltage to the signal output line BL terminates, the line control circuit 70 sets low a reset pulse to be supplied to the reset line RST connected to each of the pixel sections 100 on the first row to turn on the reset transistor RT and then the voltage control circuit 20c applies a drain voltage of −1 V, for example, to all signal output lines BL and precharges the drain region D.

Next, the voltage control section 12 restores the voltage to be supplied to the source line SL to 0 V and the reset drain voltage supply circuit 80 supplies a read voltage ramping up (monotoneous increasing) from, for example, −3V to 0 V to the reset drain line RSD connected to each of the pixel sections 100 on the first row. Since the reset transistor RT is on, the read voltage is applied from the drain region of the reset transistor RT through the floating diffusion FD to the gate electrode CG.

After supply of the read voltage starts, when the channel region of the transistor MT of each of the pixel sections 100 on the first line conducts, the potential of the drain region (signal output line BL) rises as shown in FIG. 8.

The read circuit holds the count corresponding to the value of the read voltage when the potential rises. The held count is output in sequence as an image capturing signal obtained from each of the pixel sections 100 on the first row under the control of the shift register 50. On and after the second row, drain precharge and read voltage supply are performed in sequence and an image capturing signal is output in sequence from each line.

When image capturing signals from all pixel sections 100 are output from the output amplifier 60 and still image capturing terminates, the control section 90 applies a voltage of 7 V, for example, to the n well layer 2, the voltage control section 12 supplies the same 7-V voltage as the voltage applied to the n well layer 2 to the source line SL, and the reset drain voltage supply circuit 80 applies a voltage of −7 V of the opposite polarity to the voltage applied to the n well layer 2 to all reset drain lines RSD. Since the reset transistor RT is on, when the voltage of −7 V is applied to the reset drain line RSD, the voltage is also applied through the floating diffusion FD to the gate electrode CG. Accordingly, voltage of opposite polarity is applied to the semiconductor substrate and all gate electrodes CG and the charge injected into the floating gate FG is drawn out to the semiconductor substrate and is erased.

The threshold voltage of the transistor MT after the charge erase completion is read in the read circuit 20 and a difference from the image capturing signal read from the transistor MT before the charge erase is found, whereby threshold voltage variations of the transistor MT may be corrected.

Upon completion of collective erase of the charge, the control section 90 outputs a still image capturing termination flag and when receiving the flag, the imaging apparatus sets a photographing condition required for picking up a moving image, etc., and the control section 90 restarts to capture a moving image under the setup photographing condition.

As described above, according to the solid-state imaging device in FIG. 1A and FIG. 1B, when a still image is picked up, the exposure time period is made the same in all pixel sections 100 and the charge occurring in each photoelectric conversion section 3 during the exposure time period is once stored in the floating gate FG and then the image capturing signal responsive to the charge stored in the floating gate FG is read in sequence, namely, global shutter drive is made possible. When a moving image is picked up, the exposure time period is shifted for each line and the capturing signal responsive to the charge occurring in the photoelectric conversion section 3 is read out in sequence from the line where the exposure time period terminates, namely, rolling shutter drive is made possible. Thus, still image capturing of high quality with no image shift by the global shutter drive and smooth moving image capturing by the rolling shutter drive can be made mutually compatible.

According to the solid-state imaging device, a single transistor MT is caused to function as two transistors of a drive transistor and a nonvolatile memory transistor, whereby the global shutter and the rolling shutter are made mutually compatible and thus the number of transistors provided in the pixel section 100 can be three at the minimum and microminiaturization of the pixel section 100 is facilitated.

The imaging apparatus picks up a smooth moving image by rolling shutter drive at the moving image capturing time performed in the still image capturing mode and picks up a high-quality still image with no image shift by global shutter drive at the still image capturing time. Thus, while checking an agreeable smooth moving image on the monitor, the user can determine the angle of view and can execute high-quality still image capturing, and the ease of use can be improved.

According to the imaging apparatus, at the time of moving image capturing performed in the still image capturing mode, at the image capturing time for through image display, a charge is not injected into the floating gate FG. That is, a charge is injected into the floating gate FG only when a still image is picked up, so that the durability of the floating gate FG can be improved and the reliability of the device can be improved.

According to the solid-state imaging device, before moving image capturing is restated after still image capturing is terminated, the charge injected into the floating gate FG is erased and thus at the moving image capturing time, read of the image capturing signal by the source follower circuit can always be executed under the same condition.

According to the solid-state imaging device, a MOS structure having the floating gate FG is adopted as the transistor MT, so that the charge stored in the floating gate FG is hard to receive the effect of surrounding noise charge (dark current occurring in the photoelectric conversion section 3, charge flowing in from peripheral pixel sections, etc.,). Thus, at the still image capturing time, it is made possible to generate high-quality image data with suppression of occurrence of noise caused by mix, etc., of unnecessary charge flowing in from peripheral pixel sections and dark current.

In the description given above, rolling shutter drive is performed at the moving image capturing time performed in the still image capturing mode; however, the rolling shutter drive may be executed at the time of moving image capturing performed in the moving image capturing mode (image capturing of recording image data generated from an image capturing signal continuously output at minute time intervals from the solid-state imaging device on a record medium capable of external output as a moving image).

In the description given above, as the transistor MT, a MOS transistor having the floating gate FG is taken as an example, but any other structure than the MOS structure can be adopted for the transistor MT. For example, an MNOS-type transistor structure with the floating gate FG as a nitride film and a control gate CG directly formed on the nitride film or an MONOS-type transistor structure with the floating gate FG as a nitride film may be adopted. In any case, the nitride film functions as a charge storage section for storing a charge.

In the description given above, it is assumed that the handled charge (charge taken as a signal) is a hole; however, the concept is the same if the handled charge is an electron. If the handled charge is an electron, in the drawings, the n-type region and the p-type region may be replaced and the polarity of the voltage applied to each section may be made opposite. For an injecting method of a charge into the floating gate FG, an optimum method may be adopted in response to the handled charge from among known methods.

As described above, the Specification discloses the following:

The disclosed imaging apparatus includes a plurality of pixel sections, a second transistor, a first signal read unit and a second signal read unit. The plurality of pixel sections is arranged in a row direction and a column direction orthogonal to the row direction. Each of the pixel sections includes a photoelectric conversion section, a first charge storage section and a first transistor. The first charge storage section stores a charge occurring in the photoelectric conversion section. The first transistor has a gate electrode connected to the first charge storage section and a second charge storage section provided between the gate electrode and a semiconductor substrate. The second transistor is on-off controlled as a load transistor of the first transistor. The first signal read unit injects a charge responsive to a voltage supplied to the gate electrode into the second charge storage section with the second transistor turned off. The first signal read unit reads a change in a threshold voltage of the first transistor caused by the injected charge as an image capturing signal. The second signal read unit reads a voltage output from the first transistor as an image capturing signal in response to a voltage supplied to the gate electrode with the second transistor turned on.

According to the first signal read unit, the charges corresponding to the charges occurring in the photoelectric conversion sections of all pixel sections are stored in the second charge storage section at the same time and then the image capturing signal responsive to the charge can be read. Thus, according to the first signal read unit, a global shutter with the exposure time made the same in all pixel sections can be realized and high-quality still image capturing is made possible. According to the second signal read unit, the image capturing signal can be read without injecting a charge into the second charge storage section and thus if image capturing is repeated, the durability of the first transistor can be improved. According to the second signal read unit, a rolling shutter with the exposure time shifted for each line, for example, can be realized and smooth moving image capturing is made possible.

In the disclosed imaging apparatus, each of the pixel sections includes a reset transistor which resets the potential of the first charge storage section to a predetermined potential. A reset drain voltage supply circuit supplies voltage to drains of the reset transistors separately for each pixel row composed of pixel sections arranged in the row direction. The reset drain voltage supply circuit supplies both reset voltage to reset the first charge storage sections and predetermined voltage to be applied to the gate electrodes to the drains.

In the disclosed imaging apparatus, the first signal read unit supplies read voltage to be applied to the gate electrodes to the drains by the reset drain voltage supply circuit so as to read changes in the threshold voltage of the first transistors with the reset transistors turned on. The first signal read unit applies the read voltage to the gate electrodes through the first charge storage sections from the drains.

According to the configuration, read of the image capturing signal by the first signal read unit can be realized without providing additional wiring for supplying read voltage to the gate electrode.

The disclosed imaging apparatus further includes a charge erase unit. The charge erase unit draws out charges injected into the second charge storage sections into the semiconductor substrate, and erases the charges. The charge erase unit supplies erase voltage to be applied to the gate electrodes to the drains by the reset drain voltage supply circuit so as to erase the charges injected into the second charge storage sections with the reset transistors turned on. The charge erase unit applies the erase voltage to the gate electrodes through the first charge storage sections from the drains.

According to the configuration, the charge can be erased without providing additional wiring for supplying erase voltage to the gate electrode.

In the disclosed imaging apparatus, each of the pixel sections includes a transfer transistor which transfers the charge occurring in the photoelectric conversion section to the first charge storage section. The first signal read unit turns on the transfer transistors in all pixel sections at the same time. The first signal read unit stores charges in the first charge storage sections at the same time. The first signal read unit reads image capturing signals in sequence for each pixel row composed of pixel sections arranged in the row direction. The second signal read unit turns on the transfer transistors, and stores charges in the first charge storage sections. The second signal read unit reads image capturing signals for each pixel row while the timing is shifted.

In the disclosed imaging apparatus, at the moving image capturing time, an image capturing signal responsive to the charge occurring in the photoelectric conversion section during exposure for the moving image capturing is read by the second signal read unit. At the still image capturing time, an image capturing signal responsive to the charge occurring in the photoelectric conversion section during exposure for the still image capturing is read by the first signal read unit.

According to the configuration, for example, image capturing for displaying a moving image can be performed smoothly; still image capturing for record can be executed in high quality with image shift suppressed. Thus, while checking an agreeable smooth moving image, the user can determine the angle of view and can execute high-quality still image capturing, and the ease of use can be improved.

In the disclosed imaging apparatus, when a still image capturing mode to capture a still image is set, moving image capturing is executed. When a command of still image capturing is given during the moving image capturing, still image capturing is executed, the charge stored in the second charge storage section is erased after read termination of the image capturing signal by the still image capturing, and the moving image capturing is restarted.

According to the configuration, the charge stored in the second charge storage section is erased and then moving image capturing is restarted, so that the image capturing signal can be read by the second signal read unit in a state in which the characteristic of the first transistor is matched.

In the disclosed imaging apparatus, the photoelectric conversion section and source region of the transistor and drain region of the transistor are formed in a semiconductor of the same conduction type.

In the disclosed imaging apparatus, the semiconductor includes an n type.

In the disclosed imaging apparatus, the first transistor has a MOS structure with a floating gate as the second charge storage section.

According to the configuration, the charge stored in the floating gate is hard to receive the effect of noise charge (dark current occurring in the photoelectric conversion section and charge flowing in from peripheral pixel sections until the termination of read of the signal responsive to the charge). Thus, to read the image capturing signal through the first signal read unit and generate image data, it is made possible to generate high-quality image data with suppression of occurrence of noise caused by mix, etc., of unnecessary charge flowing in from peripheral pixel sections and dark current.

In the disclosed imaging apparatus, the first transistor has a MONOS or MNOS structure with a nitride film as the second charge storage section.

In the disclosed drive method of a solid-state imaging device, the solid-state imaging device includes a plurality of pixel sections. The plurality of pixel sections is arranged in a row direction and a column direction orthogonal to the row direction. Each of the pixel sections includes a photoelectric conversion section, a first charge storage section and a first transistor. The first charge storage section stores a charge occurring in the photoelectric conversion section. The first transistor has a gate electrode connected to the first charge storage section and a second charge storage section provided between the gate electrode and a semiconductor substrate. The drive method of the solid-state imaging device includes: on-off controlling a second transistor as a load transistor of the first transistor; injecting by a first signal read unit, a charge responsive to a voltage supplied to the gate electrode into the second charge storage section with the second transistor turned off; reading by the first signal read unit, a change in a threshold voltage of the first transistor caused by the injected charge as an image capturing signal with the second transistor turned off; and reading by a second signal read unit, a voltage output from the first transistor as an image capturing signal in response to a voltage supplied to the gate electrode with the second transistor turned on.

In the disclosed drive method of the solid-state imaging device, each of the pixel sections includes a reset transistor which resets the potential of the first charge storage section to a predetermined potential. The drive method further includes: applying a read voltage to be applied to the gate electrodes to the gate electrodes through the first charge storage sections from drains of the reset transistors so as to read changes in the threshold voltage of the first transistors with the reset transistors turned on.

The disclosed drive method of the solid-state imaging device includes: applying an erase voltage to be applied to the gate electrodes to the gate electrodes through the first charge storage sections from the drains so as to erase the charge injected into the second charge storage sections; drawing out the charge injected into the second charge storage sections into the semiconductor substrate; and erasing the charge.

In the disclosed drive method of the solid-state imaging device, each of the pixel sections includes a transfer transistor which transfers the charge occurring in the photoelectric conversion section to the first charge storage section. The drive method further includes: turning on by the first signal read unit, the transfer transistors in all pixel sections at the same time; storing by the first signal read unit, charges in the first charge storage sections at the same time; reading by the first signal read unit, image capturing signals in sequence for each pixel row composed of pixel sections arranged in the row direction; turning on by the second signal read unit, the transfer transistors; storing by the second signal read unit, charges in the first charge storage sections; and reading by the second signal read unit, image capturing signals for each pixel row while the timing is shifted.

In the disclosed drive method of the solid-state imaging device, the drive method further includes: reading by the second signal read unit, an image capturing signal responsive to the charge occurring in the photoelectric conversion section during exposure for the moving image capturing at the moving image capturing time; and reading by the first signal read unit, an image capturing signal responsive to the charge occurring in the photoelectric conversion section during exposure for the still image capturing at the still image capturing time.

In the disclosed drive method of the solid-state imaging device, when a still image capturing mode to capture a still image is set the drive method further includes executing moving image capturing. When a command of still image capturing is given during the moving image capturing, the drive method further includes: executing still image capturing; erasing the charge stored in the second charge storage section after read termination of the image capturing signal by the still image capturing; and restarting the moving image capturing.

What is claimed is:

1. An imaging apparatus comprising:
a plurality of pixel sections that is arranged in a row direction and a column direction orthogonal to the row direction, each of the pixel sections including:
a photoelectric conversion section;
a first charge storage section which stores a charge occurring in the photoelectric conversion section; and
a first transistor which has a gate electrode connected to the first charge storage section and a second charge storage section provided between the gate electrode and a semiconductor substrate,
a second transistor that is on-off controlled as a load transistor of the first transistor;
a first signal read unit that injects a charge responsive to a voltage supplied to the gate electrode into the second charge storage section with the second transistor turned off and that reads a change in a threshold voltage of the first transistor caused by the injected charge as an image capturing signal; and
a second signal read unit that reads a voltage output from the first transistor as an image capturing signal in response to a voltage supplied to the gate electrode with the second transistor turned on.

2. The imaging apparatus according to claim 1, wherein
each of the pixel sections includes a reset transistor which resets the potential of the first charge storage section to a predetermined potential,
a reset drain voltage supply circuit supplies voltage to drains of the reset transistors separately for each pixel row composed of pixel sections arranged in the row direction, and
the reset drain voltage supply circuit supplies both reset voltage to reset the first charge storage sections and predetermined voltage to be applied to the gate electrodes to the drains.

3. The imaging apparatus according to claim 2, wherein
the first signal read unit (i) supplies read voltage to be applied to the gate electrodes to the drains by the reset drain voltage supply circuit so as to read changes in the threshold voltage of the first transistors with the reset transistors turned on and (ii) applies the read voltage to the gate electrodes through the first charge storage sections from the drains.

4. The imaging apparatus according to claim 3, further comprising:
a charge erase unit that draws out charges injected into the second charge storage sections into the semiconductor substrate and that erases the charges, wherein
the charge erase unit (i) supplies erase voltage to be applied to the gate electrodes to the drains by the reset drain voltage supply circuit so as to erase the charges injected into the second charge storage sections with the reset transistors turned on and (ii) applies the erase voltage to the gate electrodes through the first charge storage sections from the drains.

5. The imaging apparatus according to claim 1, wherein
each of the pixel sections comprises a transfer transistor which transfers the charge occurring in the photoelectric conversion section to the first charge storage section,
the first signal read unit (i) turns on the transfer transistors in all pixel sections at the same time and (ii) stores charges in the first charge storage sections at the same time and (iii) reads image capturing signals in sequence for each pixel row composed of pixel sections arranged in the row direction, and
the second signal read unit (i) turns on the transfer transistors and (ii) stores charges in the first charge storage sections and (iii) reads image capturing signals for each pixel row while the timing is shifted.

6. The imaging apparatus according to claim 1, wherein
at the moving image capturing time, an image capturing signal responsive to the charge occurring in the photoelectric conversion section during exposure for the moving image capturing is read by the second signal read unit, and
at the still image capturing time, an image capturing signal responsive to the charge occurring in the photoelectric conversion section during exposure for the still image capturing is read by the first signal read unit.

7. The imaging apparatus according to claim 6, wherein
when a still image capturing mode to capture a still image is set, moving image capturing is executed, and
when a command of still image capturing is given during the moving image capturing,
(i) still image capturing is executed,
(ii) the charge stored in the second charge storage section is erased after read termination of the image capturing signal by the still image capturing, and
(iii) the moving image capturing is restarted.

8. The imaging apparatus according to claim 1, wherein
the photoelectric conversion section and source region of the transistor and drain region of the transistor are formed in a semiconductor of the same conduction type.

9. The imaging apparatus according to claim 8, wherein
the semiconductor includes an n type.

10. The imaging apparatus according to claim 1, wherein
the first transistor has a MOS structure with a floating gate as the second charge storage section.

11. The imaging apparatus according to claim 1, wherein
the first transistor has a MONOS or MNOS structure with a nitride film as the second charge storage section.

12. A drive method of a solid-state imaging device including:
a plurality of pixel sections that is arranged in a row direction and a column direction orthogonal to the row direction, each of the pixel sections including:
a photoelectric conversion section;
a first charge storage section which stores a charge occurring in the photoelectric conversion section; and
a first transistor which has a gate electrode connected to the first charge storage section and a second charge storage section provided between the gate electrode and a semiconductor substrate,
the drive method comprising:
on-off controlling a second transistor as a load transistor of the first transistor;
injecting by a first signal read unit, a charge responsive to a voltage supplied to the gate electrode into the second charge storage section with the second transistor turned off;
reading by the first signal read unit, a change in a threshold voltage of the first transistor caused by the injected charge as an image capturing signal with the second transistor turned off; and
reading by a second signal read unit, a voltage output from the first transistor as an image capturing signal in response to a voltage supplied to the gate electrode with the second transistor turned on.

13. The drive method of the solid-state imaging device according to claim 12, wherein
each of the pixel sections includes a reset transistor which resets the potential of the first charge storage section to a predetermined potential, and
the drive method further comprising:
applying a read voltage to be applied to the gate electrodes to the gate electrodes through the first charge storage sections from drains of the reset transistors so as to read changes in the threshold voltage of the first transistors with the reset transistors turned on.

14. The drive method of the solid-state imaging device according to claim 13, further comprising:
applying an erase voltage to be applied to the gate electrodes to the gate electrodes through the first charge storage sections from the drains so as to erase the charge injected into the second charge storage sections;
drawing out the charge injected into the second charge storage sections into the semiconductor substrate; and
erasing the charge.

15. The drive method of the solid-state imaging device according to claim 12, wherein
each of the pixel sections comprises a transfer transistor which transfers the charge occurring in the photoelectric conversion section to the first charge storage section,
the drive method further comprises:
turning on by the first signal read unit, the transfer transistors in all pixel sections at the same time;
storing by the first signal read unit, charges in the first charge storage sections at the same time;
reading by the first signal read unit, image capturing signals in sequence for each pixel row composed of pixel sections arranged in the row direction;
turning on by the second signal read unit, the transfer transistors;
storing by the second signal read unit, charges in the first charge storage sections; and
reading by the second signal read unit, image capturing signals for each pixel row while the timing is shifted.

16. The drive method of the solid-state imaging device according to claim 12, wherein
reading by the second signal read unit, an image capturing signal responsive to the charge occurring in the photoelectric conversion section during exposure for the moving image capturing at the moving image capturing time, and
reading by the first signal read unit, an image capturing signal responsive to the charge occurring in the photoelectric conversion section during exposure for the still image capturing at the still image capturing time.

17. The drive method of the solid-state imaging device according to claim 16, wherein
executing moving image capturing when a still image capturing mode to capture a still image is set, and
when a command of still image capturing is given during the moving image capturing,
(i) executing still image capturing,
(ii) erasing the charge stored in the second charge storage section after read termination of the image capturing signal by the still image capturing, and
(iii) restarting the moving image capturing.
